(19) United States
(12) Patent Application Publication
(10) Pub. No.: US 2002/0149819 A1
(43) Pub. Date: Oct. 17, 2002

(54) OADM system and method for computing wavelength number therein

(76) Inventor: Tamotsu Sato, Miyagi (JP)

Correspondence Address: MCGINN & GIBB, PLLC, 8321 OLD COURTHOUSE ROAD, SUITE 200, VIENNA, VA, 22182-3817, US

(21) Appl. No.: 10/119,147

(22) Filed: Apr. 10, 2002

(30) Foreign Application Priority Data
Apr. 11, 2001 (JP) 2001-112877

(51) Int. Cl. G02B 6/28; H04J 14/02

(52) U.S. Cl. 359/127; 385/24

(57) ABSTRACT

A first coupler, a second coupler, FBG, a third coupler, BA, and a fourth coupler are connected in series and inserted between an input-side optical fiber and an output-side optical fiber. An input wavelength multiplexed signal is branched by a branching filter connected to the second coupler into individual wavelengths, and, based on the output of the branching filter, the number of wavelengths in branch optical signal is computed in a branch optical signal wavelength number computation section. On the other hand, the number of wavelengths in insertion optical signal is computed in an insertion optical signal wavelength number computation section based on insertion optical signal, and the number of wavelengths in input optical signal is computed based on an SV signal branched from the first coupler. The number of wavelengths in output optical signal is computed in an output optical signal wavelength number computation section based on the above numbers of wavelengths in the above three optical signals and is multiplexed into an output optical signal in the fourth coupler. By virtue of the above construction, an OADM system can be provided wherein, even when the number of multiplexed wavelengths is increased, the necessity of providing monitors for respective wavelengths of an input (output) wavelength multiplexed signal can be eliminated and, thus, a combination of the prevention of an increase in cost with an improvement in reliability can be realized.

### FIELD OF THE INVENTION

The invention relates to an OADN (optical add-drop multiplexer) system and a method for computing the number of wavelengths therein, and particularly to an OADM system which can compute the number of wavelengths without providing a monitor and the like for each wavelength in an input (output) wavelength multiplexed signal and a method for computing the number of wavelengths therein.

### BACKGROUND OP THE INVENTION

FIG. 1 shows a conventional OADM system.

A conventional OADM system 100 comprises: a demultiplexer (DMUX) 101 as a branching filter for branching an input wavelength multiplexed signal Si into individual wavelengths; optical switches (SW) 102₋₁ to 102₋ₙ connected to the demultiplexer 101; optical level controllers 103₋₁ to 103₋ₙ connected respectively to the optical switches 102₋₁ to 102₋ₙ; a multiplexer (MUX) 104 for multiplexing the wavelengths output from the optical level controllers 103₋₁ to 103₋ₙ and outputting the resultant output wavelength multiplexed signal So: and level monitors 106₋₁ to 106₋ₙ connected respectively to optical fibers 105₋₁ to 105₋ₙ for connecting the optical switches 102₋₁ to 102₋ₙ to the optical level controllers 103₋₁ to 103₋ₙ.

In the input wavelength multiplexed signal Si, wavelengths λ1 to λn are in the state of being multiplexed, and the input wavelength multiplexed signal Si is branched by the demultiplexer 101 into individual wavelengths λ1, λ2, λ3, . . . to λn. The optical signals respectively with branched wavelengths λ1 to λn are input into corresponding optical switches 102₋₁ to 102₋ₙ, and are if necessary taken out to the outside of the system as a branch optical signal Sd. On the other hand, an optical signal with any desired wavelengths λ1 to λn is externally inserted as an insertion optical signal Sa into the optical switches 102₋₁ to 102₋ₙ. The signals from the optical switches 102₋₁ to 102₋ₙ are monitored respectively with the level monitors 106₋₁ to 106₋ₙ and are respectively subjected to level matching by means of the optical level controllers 103₋₁ to 103₋ₙ so that the wavelength variation is corrected. The optical signals λ1 to λn subjected to level matching by means of the optical level controllers 103₋₁ to 103₋ₙ are input into the multiplexer 104 for multiplexing, and the resultant output wavelength multiplexed signal So is output from the multiplexer 104.

In the OADM system, the number of wavelengths of the input wavelength multiplexed signal is computed by using output signals of the level monitors 106₋₁ to 106₋ₙ or by a monitor circuit or the like separately provided in a transmission path for each wavelength in the input wavelength multiplexed signal. In wavelength multiplex transmission not including any OADM system, the number of wavelengths has hitherto been computed by a terminal and transmitted as an SV signal (a system monitoring signal). On the other hand, in a repeater station, since neither branching nor insertion is carried out, there is no increase or decrease in number of wavelengths. This has eliminated the need to compute the number of wavelengths in the repeater station. On the other hand, in wavelength multiplex transmission including an OADM system, in a repeater station, to which OADM has been added, an optical signal is branched or inserted. Further, since the number of wavelengths in the branch optical signal is not always identical to the number of wavelengths in the insertion optical signal, the number of wavelengths in the input wavelength multiplexed signal Si is not sometimes identical to the number of wavelengths in the output wavelength multiplexed signal So. Therefore, in the repeater station to which OADM is added, the number of wavelengths should be computed. To this end, information of the number of wavelengths is sent from a preceding stage to a subsequent stage.

In the conventional OADM system, however, the number of optical wavelengths has been computed by means of level monitors 106₋₁ to 106₋ₙ provided for respective wavelengths in the input wavelength multiplexed signal or other instrument. Therefore, even in the case where level matching among wavelengths in the optical signals is not carried out, the provision of instruments such as a large number of level monitors corresponding to the number of multiplexed wavelengths are necessary when the computation of the number of optical wavelengths is contemplated. An increase in number of components (instruments) used leads to an increase in cost and, in addition, increases failure rate of components.

### SUMMARY OF THE INVENTION

Accordingly, it is an object of the invention to provide an OADM system, which, even when the number of multiplexed wavelengths is increased, can eliminate the need to provide monitors for respective wavelengths in the input (output) wavelength multiplexed signal and can realize a combination of the prevention of an increase in cost with improve reliability.

It is another object of the invention to provide a method for computing the number of wavelengths in an OADM system which can compute the number of wavelengths without monitoring each wavelength in the pass wavelength multiplexed signal except for branch/insertion wavelength.

According to the first feature of the invention, an OADM (optical add-drop multiplexer) system for subjecting a wavelength multiplexed input optical signal to branching/insertion of optical signal by OADM to form an output wavelength multiplexed signal which is then output, comprises input optical signal wavelength number computation means for computing the number of wavelengths in said input optical signal; branch optical signal wavelength number computation means for branching the input optical signal into individual wavelengths and computing the number of wavelengths in branch optical signal based on the branched wavelengths; insertion optical signal wavelength number computation means for computing the number of wavelengths in insertion optical signal; output optical signal wavelength number computation means for computing the number of wavelengths in output optical signal based on the number of wavelengths in input optical signal determined by the input optical signal wavelength number computation means, the number of wavelengths in branch optical signal determined by the branch optical signal wavelength number computation means, and the number of wavelengths in insertion optical signal determined by the insertion optical signal wavelength number computation means; and multiplexing means for multiplexing the number of wavelengths in output optical signal determined by the output optical signal wavelength number computation means into an optical signal output from said OADM.

According to this construction, the number of wavelengths in output optical signal is computed by the output optical signal wavelength number computation means based on the numbers of wavelengths in three optical signals, i.e., the number of wavelengths in input optical signal computed by the input optical wavelength number computation means, the number of wavelengths in branch optical signal computed by the branch optical signal wavelength number computation means, and the number of wavelengths in insertion optical signal computed by the insertion optical signal wavelength number computation means. The number of wavelengths in output optical signal thus obtained is multiplexed into the output optical signal of OADM by multiplexing means to form an output wavelength multiplexed signal. By virtue of this construction, even when the number of multiplexed wavelengths is increased, there is no need to provide a monitor or the like for each wavelength. This contributes to a reduction in cost and, at the same time, can realize improved reliability.

According to the second feature of the invention, an OADM (optical add-drop multiplexer) system for subjecting a wavelength multiplexed input optical signal to branching/insertion of optical signal by OADM to form an output wavelength multiplexed signal which is then output, comprises,. level detection means for detecting the optical level of the input optical signal; insertion optical signal wavelength number computation means for computing the number of wavelengths in insertion optical signal; output optical signal wavelength number computation means which, when the level detection means has detected that the level of the input optical signal does not reach a specific value, uses the number of wavelengths in the insertion optical signal, determined by the insertion optical signal wavelength number computation means, as the number of wavelengths in the output wavelength multiplexed signal; and multiplexing means for multiplexing the number of wavelengths in the output optical signal determined by the output optical signal wavelength number computation means into an optical signal output from said OADM.

According to this construction, the number of wavelengths in the insertion optical signal is computed by the insertion optical signal wavelength number computation means, and, when the optical level of the input wavelength multiplexed signal does not reach a specified value, the number of wavelengths in the insertion optical signal is used as the number of wavelengths in output wavelength multiplexed signal. By virtue of this construction, even when the input wavelength multiplexed signal is not input due to some trouble, the number of wavelengths in output optical signal can be computed.

According to the third feature of the invention, an OADM (optical add-drop multiplexer) system comprises: a first coupler into which an input wavelength multiplexed signal is input; a branching filter connected to the first coupler, for branching the input wavelength multiplexed signal into individual wavelengths; a branch optical signal wavelength number computation section for computing the number of wavelength in branch optical signal based on the output of the branching filter; an insertion optical signal wavelength number computation section for computing the number of wavelengths in insertion optical signal; a second coupler for multiplexing the single or plurality of insertion optical signals into the optical signal output from the first coupler; an input optical signal wavelength number computation section for computing the number of wavelengths in the input optical signal of the input wavelength multiplexed signal based on a system monitoring optical signal branched from the first coupler; an output optical signal wavelength number computation section for computing the number of wavelengths in output optical signal based on the number of wavelengths in input optical signal determined by the input optical signal wavelength number computation section, the number of wavelengths in branch optical signal determined by the branch optical signal wavelength number computation section, and the number of wavelengths in insertion optical signal determined by the insertion optical signal wavelength number computation section; and a third coupler for multiplexing the number of wavelengths in output optical signal, determined by the output optical signal wavelength number computation section, into the optical signal output from the second coupler.

According to this construction, the number of wavelengths in output optical signal is computed in the output optical signal wavelength number computation section based on the number of wavelengths in input optical signal computed by the input optical wavelength number computation section, the number of wavelengths in branch optical signal computed by the branch optical signal wavelength number computation section, and the number of wavelengths in insertion optical signal computed by the insertion optical signal wavelength number computation section. The number of wavelengths in output optical signal thus obtained is multiplexed in the third coupler into the optical signal output from the second coupler to form an output wavelength multiplexed signal. By virtue of this construction, even when the number of multiplexed wavelengths is increased, there is no need to provide a level monitor or the like for each wavelength. This contributes to a reduction in cost and, at the same time, can realize improved reliability.

According to the fourth feature of the invention, a method for computing the number of wavelengths in output optical signal in an OADM (optical add-drop multiplexer) system for use in wavelength multiplex transmission, comprises computing the number of wavelengths in the output optical signal by the following equation: A=X−Y+Z wherein A represents the number of wavelengths in the output optical signal; X represents the number of wavelengths in input optical signal of an input wavelength multiplexed signal; Y represents the number of wavelengths in branch optical signal computed based on branch optical signals obtained by branching the input wavelength multiplexed signal into individual wavelengths; and Z represents the number of wavelengths in insertion optical signal inserted into a pass wavelength multiplexed signal obtained after branching of the input wavelength multiplexed signal.

According to this method, the number of wavelengths (A) in output optical signal is determined by [number of wavelengths (X) in input optical signal−number of wavelengths (Y) in branch optical signal+number of wavelengths (Z) in insertion optical signal]. By virtue of this construction, the number of wavelengths can be computed while eliminating the need to provide a monitor or the like for each wavelength for determining the number of wavelengths (A) in output optical signal and without incurring an increase in cost of the OADM system.

According to the fifth feature of the invention, a method for computing the number of wavelengths in output optical signal in an OADM (optical add-drop multiplexer) system for use in wavelength multiplex transmission, comprises the steps of: computing the number of wavelengths in insertion optical signal based on the insertion optical signal; generating information on input interruption when the optical level of an input wavelength multiplexed signal does not reach a specified value; and, upon the generation of the information on input interruption, using the number of wavelengths in the insertion optical signal as the number of wavelengths in the output optical signal.

According to this method, when the optical level of the input wavelength multiplexed signal does not reach a specified value, the number of wavelengths in insertion optical signal computed based on the insertion optical signal is used as the number of wavelengths in output wavelength multiplexed signal. By virtue of this construction, while eliminating the need to provide a monitor or the like for each wavelength, the number of wavelengths in output optical signal can be computed even when the input wavelength multiplexed signal is not input due to some trouble.

### BRIEF DESCRIPTION OF THE DRAWINGS

The invention will be explained in more detail in conjunction with the appended drawings, wherein:

FIG. 1 is a block diagram showing a conventional OADM system;

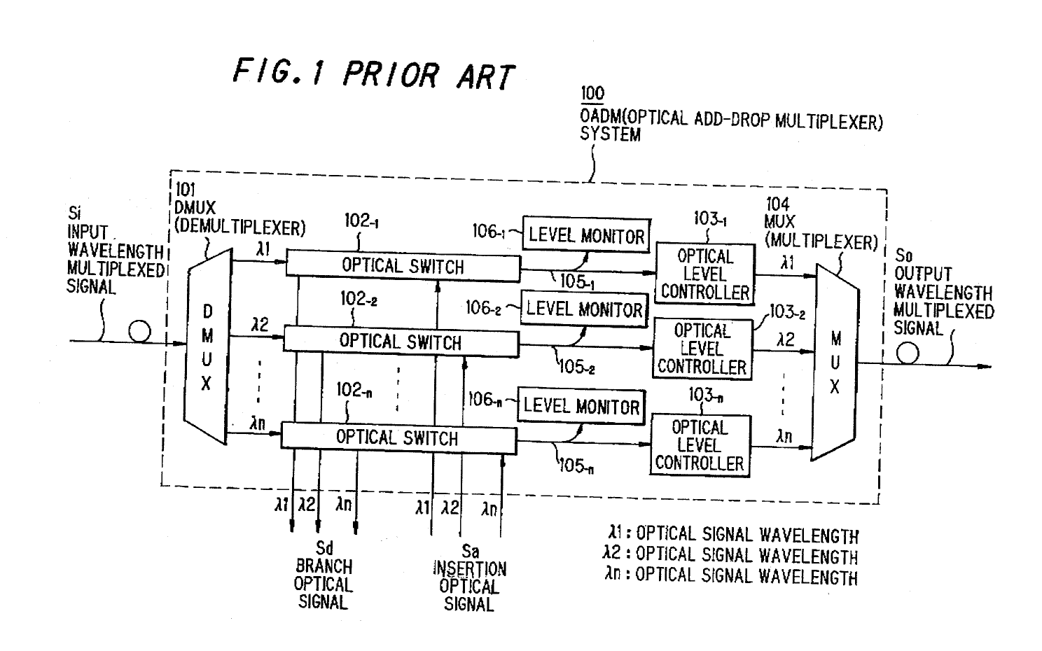

FIG. 2 is a block diagram showing an OADM system according to the invention;

FIG. 3 is a block diagram showing the detailed construction of a branch optical signal wavelength number computing section and an insertion optical signal wavelength number computing section shown in FIG. 2; and

FIG. 4 is a diagram illustrating the operation of each section of the OADM system according to the invention.

DESCRIPTION OF THE PREFERRED EMBODIMENTS

Preferred embodiments of the invention will be explained in conjunction with the accompanying drawings.

[First Preferred Embodiment]

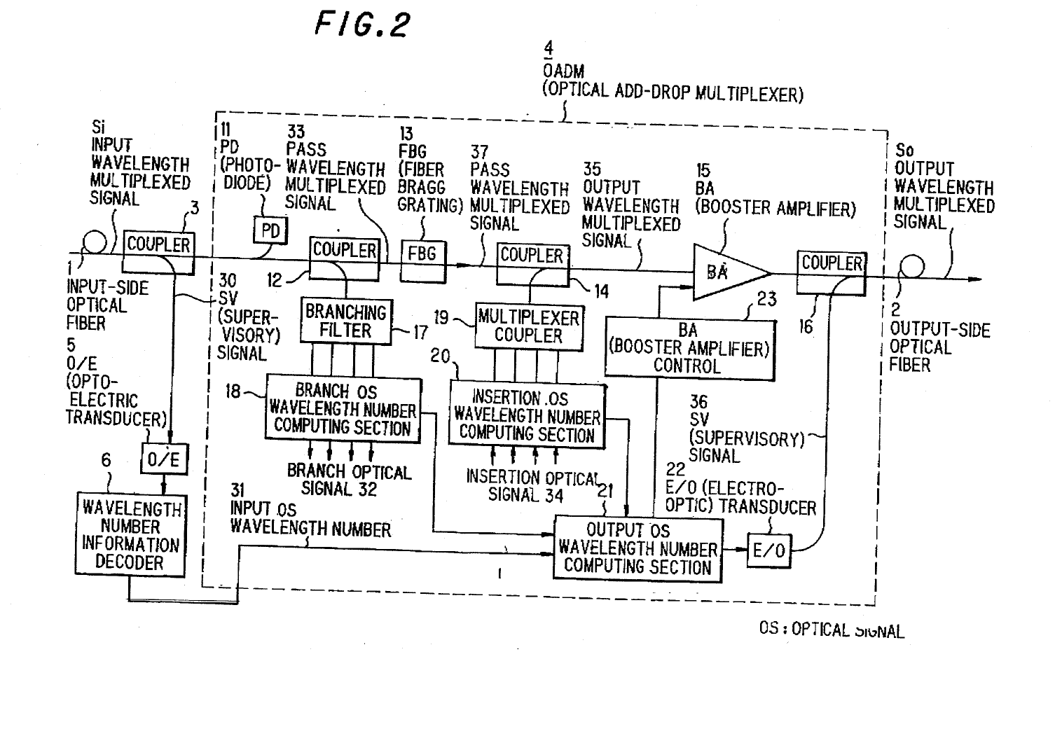

FIG. 2 shows an OADM system according to the invention.

A coupler 3 and OADM 4 are connected in series and inserted into between an input-side optical fiber 1, into which an input wavelength multiplexed signal Si is input, and an output-side optical fiber 2 from which an output wavelength multiplexed signal So is output. An opto-electric transducer (O/E) 5 and a wavelength number information decoder 6 are connected in series to the coupler 3, and a signal (number of wavelengths in input optical signal) output from the wavelength number information decoder 6 is input into OADM 4.

OADM 4 comprises: a photodiode (PD) 11 connected to the coupler 3; a coupler 12 connected to PD 11; FBG (fiber bragg grating) 13 connected to the coupler 12; a coupler 14 connected to FBG 13; BA (booster amplifier) 15; a coupler 16 connected to BA; a branching filter 17 connected to the coupler 12; a branch optical signal wavelength number computing section 18 connected to the branching filter 17; a multiplexing coupler 19 connected to the coupler 14; an insertion optical signal wavelength number computing section 20 connected to the multiplexing coupler 19; an output optical signal wavelength number computing section 21 connected to the insertion optical signal wavelength number computing section 20; an electro-optic transducer (E/O) 22 connected between the output optical signal wavelength number computing section 21 and the coupler 16; and a BA controller 23 connected between the output optical signal wavelength number computing section 21 and BA 15.

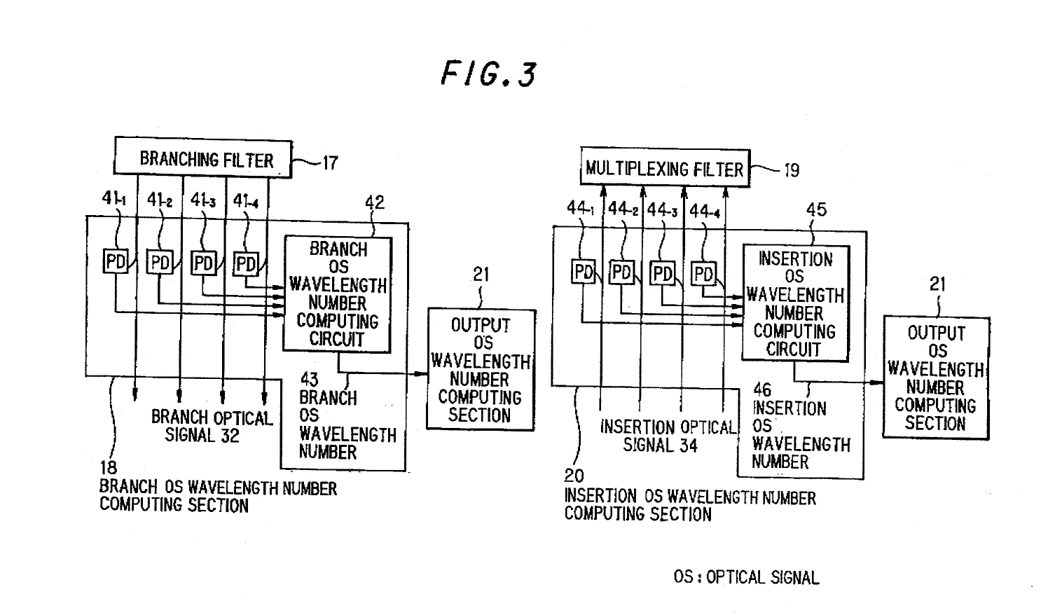

FIG. 3 shows the construction of the branch optical signal wavelength number computing section 18 and the insertion optical signal wavelength number computing section 20. The branch optical signal wavelength number computing section 18 comprises: photodiodes (PDs) 41₋₁ to 41₋₄ for detecting the optical level of the branch optical signal sent from the coupler 12; and a branch optical signal wavelength number computing circuit 42 for computing the number of wavelengths 43 in the branch optical signal based on the signal output from the photodiodes 41₋₁ to 41₋₄. On the other hand, the insertion optical signal wavelength number computing section 20 comprises: photodiodes (PDs) 44₋₁ to 44₋₄ for detecting the branch optical signal output from the coupler 14; and an insertion optical signal wavelength number computing circuit 45 for computing the number of wavelengths 46 in the insertion optical signal based on the signal output from the photodiodes 44₋₁ to 44₋₄.

In the above construction, three elements of the number of wavelengths 31 in the input optical signal, the number of wavelengths 43 in the branch optical signal, and the number of wavelengths 46 in the insertion optical signal are computed respectively by the wavelength number information decoder 6, the branch optical signal wavelength number computing section 18, and the insertion optical signal wavelength number computing section 20, and the output optical signal wavelength number computing section 21 computes the number of wavelengths in the output wavelength multiplexed signal So.

Next, the operation of the OADM system having a construction shown in FIG. 2 will be explained.

An input wavelength multiplexed signal Si containing an SV signal (a supervisory signal: an optical signal containing wavelength number information for monitoring the system) 30 sent from a preceding-stage system (not shown) is branched by means of the coupler 3 into an SV signal 30 and an optical signal (input wavelength multiplexed signal Si). The SV signal 30 is converted by the opto-electric transducer 5 to an electric signal, and, based on the electric signal, the wavelength number information decoder 6 decodes the number of wavelengths 31 in the input optical signal which is then output.

The level of the input wavelength multiplexed signal Si is monitored with the photodiode 11, and, in addition, the input wavelength multiplexed signal Si is branched by the coupler 12 into a branch optical signal 32 and a pass wavelength multiplexed signal 33. Only optical signals with wavelengths designated as branch/insertion wavelengths in the branch optical signal 32 are passed through the branching filter 17, and the transmitted optical signal is input into the branch optical signal wavelength number computing section 18. In the branch optical signal wavelength number computing section 18, levels of the respective wavelengths in the branch optical signal 32 are monitored with the photodiodes 41₋₁ to 41₋₄ and, when the wavelength level does not reach a specified value, an alarm is output as “output interruption.” In the branch optical signal wavelength number computing section 18, the number of wavelengths 43 in the branch optical signal can be obtained by subtracting the number of output interruption alarms from the number of ports of the branch optical signal (“4” in this embodiment).

When the pass wavelength multiplexed signal 33 is passed through FBG 13, a signal component of the branch optical signal wavelengths is removed. Therefore, the number of wavelengths in the pass wavelength multiplexed signal 33 may be determined by subtracting the number of wavelengths 43 in the branch optical signal from the number of wavelengths 31 in the input optical signal. The number of wavelengths 46 in the insertion optical signal is determined in the insertion optical signal wavelength number computing section 20 in the same manner as described above in connection with the branch optical signal. Levels of respective wavelengths in the insertion optical signal are monitored with photodiodes 44₋₁ to 44₋₄. For wavelengths having a level which does not reach a specified value, the photodiodes 44₋₁ to 44₋₄ detect an alarm as “input interruption.” In the insertion optical signal wavelength number computing circuit 45, the number of wavelengths 46 in the insertion optical signal can be obtained by subtracting the number of input interruption alarms from the number of ports of the insertion optical signal (“4” in this case).

Insertion optical signals with respective wavelengths in the insertion optical signal 34, which has been passed through the insertion optical signal wavelength number computing section 20, are multiplexed in the multiplexing coupler 19, followed by multiplexing into the pass wavelength multiplexed signal 33 sent from FBG 13 in the coupler 14. The multiplexed signal is input as an output wavelength multiplexed signal 35 into BA 15. The number of wavelengths in the output wavelength multiplexed signal 35 is determined in the output optical signal wavelength number computing section 21 by the following equation.

Number of wavelengths A in output optical signal=number of wavelengths in pass wavelength multiplexed signal (33)+number of wavelengths (46) in insertion optical signal=number of wavelengths (31) in input optical signal−number of wavelengths (43) in branch optical signal+number of wavelengths (46) in insertion optical signal (1)

The number of wavelengths A in output optical signal determined by the above method is used as control information for a BA control unit 23 for controlling the power output from BA 15 and, in addition, is converted by an electro-optic transducer 22 to an optical signal which is used as an SV signal 36. This SV signal 36 is multiplexed by the coupler 16 into the output wavelength multiplexed signal 35, and the multiplexed signal is then transmitted to a next-stage system (not shown).

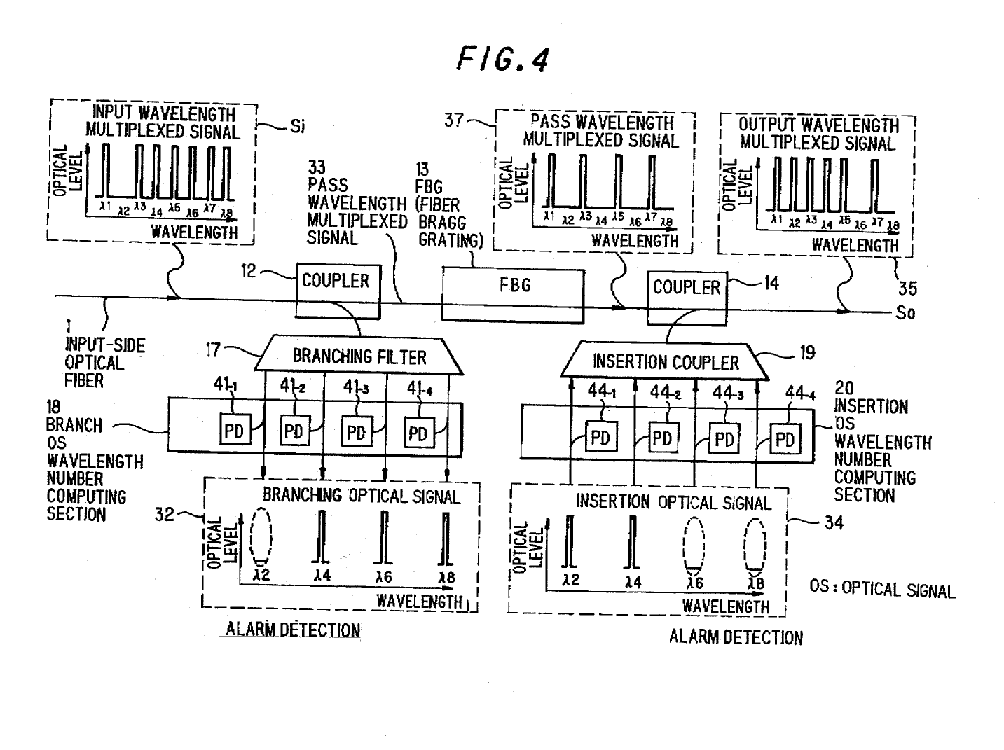

FIG. 4 shows the operation of each section in the OADM system according to the invention.

Here four wavelengths of λ2, λ4, λ6, and λ8 are branched, and wavelengths λ2 and λ4 are inserted. An input wavelength multiplexed signal Si contains seven waves (X) of λ1 and λ3 to λ8. Among them, four waves of λ2, λ4, λ6, and λ8 are set as wavelengths to be transmitted through the branching filer 17 and the multiplexing coupler 19. Further, the number of wavelengths in the input wavelength multiplexed signal Si has already been computed as X=7 waves in the preceding-stage system.

The input wavelength multiplexed signal Si is passed through the coupler 3 and is then branched in the coupler 12. Only optical signals with single wavelengths of λ4, λ6, and λ8 in the optical signal branched by the coupler 12 are passed through the branching filter 17, and the levels of respective branched optical signals are monitored. For the wavelength λ2, since this wavelength is not contained in the input wavelength multiplexed signal Si, the level thereof does not reach a specified value of the signal detection level. Therefore, an alarm as output interruption is reported from the branch optical signal wavelength number computing section 18. The number of wavelengths Y in the branch optical signal may be determined by subtracting the number of output interruption alarms from the number of branch optical signal ports (four ports in this case) as follows.

Y=4 (number of branch optical signal ports)−1 (number of signal interruption alarms of λ2)−3[waves] (2)

Further, insertion optical signals 34 with λ2 and λ4 are inserted from the insertion optical signal wavelength number computing section 20 in its insertion optical signal port. Here again, levels of respective wavelengths are monitored in the insertion optical signal wavelength number computing section 20, and input interruption alarms are reported for the wavelengths λ6 and λ8. In the same manner as used in the computation of the number of wavelengths in the branch optical signal, the number of input interruption alarms may be subtracted from the number of insertion optical signal ports (number of insertion optical signal wavelengths) to determine the number of wavelengths Z in the insertion optical signal:

Z=4 (number of insertion optical signal ports)−2 (number of signal interruption alarms of λ6 and λ8)=[waves]

The insertion optical signal is multiplexed in the insertion optical signal wavelength number computing section 20, and the multiplexed signal is then input into the coupler 14.

Only branch wavelengths (λ2, λ4, λ6, and λ8) are removed by FBG 13 from the pass wavelength multiplexed signal 33 sent from the coupler 12, followed by Bending to the coupler 14. In the coupler 14, the pass wavelength multiplexed signal 37 from FBG 13 is multiplexed with the branch optical signal 32 from the multiplexing coupler 19. The output wavelength multiplexed signal 35 produced by the multiplexing is optically amplified by BA 15. An SV signal 36 is then multiplexed in the coupler 16 into the output wavelength multiplexed signal 35, and the output wavelength multiplexed signal So produced by this multiplexing is then sent to a next-stage system. The number of wavelengths A in the output wavelength multiplexed signal So is determined by the following equation

A=X−Y+Z (3)

In FIG. 3, the number of wavelengths Y in the branch optical signal is 3, the number of wavelengths z in the insertion optical signal is 2, and the number of wavelengths X in the input wavelength multiplexed signal is 7. Therefore, the number of wavelengths A in the output wavelength multiplexed signal So is A=7−3+2=6 [waves].

As explained above, according to the preferred embodiment of the invention, levels of respective wavelengths in the input wavelength multiplexed signal Si are not monitored. Therefore, unlike the prior art technique, there is no need to provide monitor circuits for respective wavelengths in the input (output) wavelength multiplexed signal. In a system utilizing OADM, there is a tendency that the number of the pass wavelength multiplexed signals is larger than the number of branch/insertion signals. Therefore, the invention, which can compute the number of wavelengths in the output wavelength multiplexed signal based on the number of wavelengths of the branch/insertion signals, contributes to a significant reduction: in number of components which in its turn can reduce the cost of the system. Further, according to the preferred embodiment of the invention, the reliability of the system can be improved by virtue of the reduction in components. Specifically, since the number of components can be reduced, failure rate depending upon the components is lowered, contributing to improved reliability of the system.

[Second Preferred Embodiment]

The preferred embodiment is on the assumption that the input wavelength multiplexed signal Si exists. There is a possibility that the input wavelength multiplexed signal Si is not input due to the occurrence of some trouble. A method for computing the number of wavelengths in output optical signal in this case will be explained

A case, where, in FIG. 2, the input wavelength multiplex signal Si is interrupted in a portion between the coupler 3 and the photodiode 11, will be considered. In this case, the coupler 3 normally receives the input wavelength multiplexed signal Si, and, in the coupler 3, the SV signal 30 is branched. Therefore, the number of wavelengths transmitted from the preceding stage is decoded in the wavelength number information decoder 6. In this situation, despite the fact that the input wavelength multiplexed signal Si is not input into the photodiode 11, the number of wavelengths transmitted from the preceding stage is counted in the wavelength number information decoder 6. Therefore, when the same computation method as used in the case of the presence of the input wavelength multiplexed signal Si is adopted, an erroneous information on the number of wavelengths is transmitted to the next stage.

Therefore, when the level of the input signal in the photodiode 11 does not reach a specified value, an alarm of “input interruption” is reported. In this case, since the number of wavelengths in the input wavelength multiplexed signal Si and the number of wavelengths in the branch optical signal 32 are “0 (zero),” the following calculation formula is adopted.

A(number of wavelengths in output wavelength multiplexed signal)=Z(number of wavelengths in insertion optical signal 46)=number of ports of insertion optical signal−input interruption alarms of insertion optical signal (4)

For example, in FIG. 4, the number of ports of insertion optical signal is “4,” and the number of branch optical signal 32 is “2.” Therefore, the number of wavelengths in the output wavelength multiplexed signal is A=4−2=2. In this way, even when no signal is input from the preceding stage, the normal number of wavelengths can be transmitted to the next stage.

As is apparent from the foregoing description, in the first OADM system according to the invention, the number of wavelengths in input optical signal, the number of wavelengths in branch optical signal, and the number of wavelengths in insertion optical signal are computed, the number of wavelengths in output optical signal is computed by output optical signal wavelength number computation means based on the numbers of wavelengths in these three optical signals, and the number of wavelengths in output optical signal is multiplexed into the output optical signal of OADM by multiplexing means. By virtue of this construction, even when the number of multiplexed wavelengths is increased, there is no need to provide a monitor or an optical level controller for each wavelength. This contributes to a reduction in cost and, at the same time, can realize improved reliability.

In the second OADM system according to the invention, the number of wavelengths in insertion optical signal is computed by insertion optical signal wavelength number computation means based on the insertion optical signal, and, when the optical level of the input wavelength multiplexed signal does not reach a specified value, the number of wavelengths in insertion optical signal is used as the number of wavelengths in output wavelength multiplexed signal. By virtue of this construction, even when the input wavelength multiplexed signal is not input due to some trouble, the number of wavelengths in output optical signal can be computed.

The third OADM system according to the invention comprises: input optical signal wavelength number computation means for computing the number of wavelengths in input optical signal; a branch optical signal wavelength number computation section for computing the number of wavelengths in branch optical signal; an insertion optical signal wavelength number computation section for computing the number of wavelengths in insertion optical signal; and an output optical signal wavelength number computation section for computing the number of wavelengths in output optical signal based on these outputs. By virtue of this construction, even when the number of multiplexed wavelengths is increased, there is no need to provide a monitor or an optical level controller for each wavelength. This contributes to a reduction in cost and, at the same time, can realize improved reliability.

In the method for computing the number of wavelengths in the first OADM system according to the invention, the number of wavelengths (A) in output optical signal is determined by [number of wavelengths (X) in input optical signal−number of wavelengths (Y) in branch optical signal+number of wavelengths (Z) in insertion optical signal]. By virtue of this construction, the number of wavelengths can be computed while eliminating the need to provide a monitor or the like for each wavelength for determining the number of wavelengths (A) in output optical signal and without incurring an increase in cost of the OADP system.

In the method for computing the number of wavelengths in the second OADM system according to the invention, when the optical level of the input wavelength multiplexed signal does not reach a specified value, the number of wavelengths in insertion optical signal computed based on the insertion optical signal is used as the number of wavelengths in output wavelength multiplexed signal. By virtue of this construction, while eliminating the need to provide a monitor or the like for each wavelength, the number of wavelengths in output optical signal can be computed even when the input wavelength multiplexed signal is not input due to some trouble.

The invention has been described in detail with particular reference to preferred embodiments, but it will be understood that variations and modifications can be effected within the scope of the invention as set forth in the appended claims.

What is claimed is:

1. An OADM (optical add-drop multiplexer) system for subjecting a wavelength multiplexed input optical signal to branching/insertion of optical signal by OADM to form an output wavelength multiplexed signal which is then output, said OADM system comprising:
input optical signal wavelength number computation means for computing the number of wavelengths in said input optical signal;
branch optical signal wavelength number computation means for branching the input optical signal into individual wavelengths and computing the number of wavelengths in branch optical signal based on the branched wavelengths;
insertion optical signal wavelength number computation means for computing the number of wavelengths in insertion optical signal;
output optical signal wavelength number computation means for computing the number of wavelengths in output optical signal based on the number of wavelengths in input optical signal determined by the input optical signal wavelength number computation means, the number of wavelengths in branch optical signal determined by the branch optical signal wavelength number computation means, and the number of wavelengths in insertion optical signal determined by the insertion optical signal wavelength number computation means; and
multiplexing means for multiplexing the number of wavelengths in output optical signal determined by the output optical signal wavelength number computation means into an optical signal output from said OADM.

2. An OADM (optical add-drop multiplexer) system for subjecting a wavelength multiplexed input optical signal to branching/insertion of optical signal by OADM to form an output wavelength multiplexed signal which is then output, said OADM system comprising:
level detection means for detecting the optical level of the input optical signal;
insertion optical signal wavelength number computation means for computing the number of wavelengths in insertion optical signal;
output optical signal wavelength number computation means which, when the level detection means has detected that the level of the input optical signal does not reach a specific value, uses the number of wavelengths in the insertion optical signal, determined by the insertion optical signal wavelength number computation means, as the number of wavelengths in the output wavelength multiplexed signal; and
is multiplexing means for multiplexing the number of wavelengths in the output optical signal determined by the output optical signal wavelength number computation means into an optical signal output from said OADM.

3. An OADM (optical add-drop multiplexer) system comprising:
a first coupler into which an input wavelength multiplexed signal is input;
a branching filter connected to the first coupler, for branching the input wavelength multiplexed signal into individual wavelengths;
a branch optical signal wavelength number computation section for computing the number of wavelength in branch optical signal based on the output of the branching filter;
an insertion optical signal wavelength number computation section for computing the number of wavelengths in insertion optical signal;
a second coupler for multiplexing the single or plurality of insertion optical signals into the optical signal output from the first coupler;
an input optical signal wavelength number computation section for computing the number of wavelengths in the input optical signal of the input wavelength multiplexed signal based on a system monitoring optical signal branched from the first coupler;
an output optical signal wavelength number computation section for computing the number of wavelengths in output optical signal based on the number of wavelengths in input optical signal determined by the input optical signal wavelength number computation section, the number of wavelengths in branch optical signal determined by the branch optical signal wavelength number computation section, and the number of wavelengths in insertion optical signal determined by the insertion optical signal wavelength number computation section; and
a third coupler for multiplexing the number of wavelengths in output optical signal, determined by the output optical signal wavelength number computation section, into the optical signal output from the second coupler.

4. The OADM system according to claim 3, wherein the branch optical signal wavelength number computation section comprises:
a plurality of photodiodes respectively for detecting the optical levels of optical signals output from the branching filter; and
a branch optical signal wavelength number computation circuit for computing the number of wavelengths in the branch optical signal based on detection signals of the plurality of photodiodes.

5. The OADM system according to claim 3, wherein the insertion optical signal wavelength number computation section comprises:
a plurality of photodiodes respectively for detecting the optical levels of the insertion optical signals; and
an insertion optical signal wavelength number computation section for computing the number of wavelengths in the insertion optical signal based on detection signals of the plurality of photodiodes.

6. A method for computing the number of wavelengths in output optical signal in an OADM (optical add-drop multiplexer) system for use in wavelength multiplex transmission, wherein
the number of wavelengths in the output optical signal is computed by the following equation:
A=X−Y+Z
wherein
A represents the number of wavelengths in the output optical signal;
X represents the number of wavelengths in input optical signal of an input wavelength multiplexed signal;
Y represents the number of wavelengths in branch optical signal computed based on branch optical signals obtained by branching the input wavelength multiplexed signal into individual wavelengths; and
Z represents the number of wavelengths in insertion optical signal inserted into a pass wavelength multiplexed signal obtained after branching of the input wavelength multiplexed signal.

7. A method for computing the number of wavelengths in output optical signal in an OADM (optical add-drop multiplexer) system for use in wavelength multiplex transmission, said method comprising the steps of:
computing the number of wavelengths in insertion optical signal;
generating information on input interruption when the optical level of an input wavelength multiplexed signal does not reach a specified value; and
upon the generation of the information on input interruption, using the number of wavelengths in the insertion optical signal as the number of wavelengths in the output optical signal.
